(19) United States
(12) Patent Application Publication
(10) Pub. No.: US 2002/0087702 A1
(43) Pub. Date: Jul. 4, 2002

(54) Remote contents displaying method with adaptive remote font

(76) Inventor: Koichi Mori, Takatsu-ku (JP)

Correspondence Address: BANNER & WITCOFF, 1001 G STREET N W, SUITE 1100, WASHINGTON, DC, 20001, US

(21) Appl. No.: 09/750,275

(22) Filed: Dec. 29, 2000

(51) Int. Cl. G06F 15/16

(52) U.S. Cl. 709/228; 709/227

(57) ABSTRACT

A method and system for displaying contents on a client terminal device received over a communication link, such as a computer network (i.e., the Internet) or a mobile telecommunications network, is disclosed. A request is received at a host terminal device from the client terminal device for selected content. A set of font images is then selected from a font library based on the determined frequency of selected font characteristics. The selected set of font images has fewer font images than the font library. The selected set of font images is preferably compressed and sent from the host terminal device to the client terminal device over the communication link. Next, the content, which contains content location information and font pattern codes, is preferably compressed and sent to the client terminal device over the communication link on a page-by-page basis. The content is then displayed at the client terminal device based on the selected set of font images, the content location information and the font pattern codes for the content.

### BACKGROUND OF THE INVENTION

1. Field of the Invention

The present invention relates to computer network communications. More particularly, the present invention relates to a method and system for displaying content at a client terminal device.

2. Description of the Related Art

For network-oriented electronic publishing of text-centric contents to gain wider acceptance, dedicated portable reading devices, such as portable remote terminals and electronic books, must provide a more comfortable reading experience than that experienced when reading text-centric contents on a personal computer (PC). One approach for providing a more comfortable reading experience is to display content in a rich-styled text. Nevertheless, such portable reading devices usually have limited resources, such as a relatively small amount of memory that can be used for storing a font set for displaying rich-styled text. Consequently, conventional portable reading devices display relatively poor-styled contents.

Another requirement for a portable reading device to gain wide acceptance is for the portable reading device to be lightweight and have a low power consumption. Thus, computational capability of a portable reading device must be relatively minimal. This requirement also presents an obstacle for conventional portable reading devices because complex computational capability is required for displaying rich-styled text.

Yet another problem associated with a portable reading device is that of software updating when contents parsing and text formatting are performed on a portable reading device. One instance when software updating is necessary is when a file format is changed. Another instance is when a new file format is released.

Still another problem with portable reading devices exists in certain character code systems, such as a Japanese-language environment, in which the existence of some characters that are not included in standard character codes combined with the limited memory resources associated with portable reading devices often confuses users.

One approach for overcoming the some of problems associated with portable reading devices is for content to be stored as a compressed image file. Improved conventional image compression technologies have provided a significant compression ratio, but the compressed size of a typical text file is still much larger than the available memory in a portable reading device. Additionally, the computation requirements for image decompression and inflexible formatting remain obstacles that must be overcome.

Another approach for overcoming problems associated with portable reading devices has been to use formatted text data having embedded necessary font data. For example, Adobe's PDF (Portable Document Format) can include font data and can be loaded page by page. Thus, a PDF file must include all the necessary font data and fixed format, much like printing the content on paper. Moreover, a terminal device requires dedicated reader software, so terminal device users are required to periodically update software.

Yet another approach is for a server in a network to take charge of updating a screen, or page, by sending an updated part of the screen to a terminal. Systems, such as a thin-client computer system or a thin-network computer system, have a server-centric mechanism and applications, such as word processor or spreadsheets, in which a small screen update occurs, work well. Nevertheless, because page-oriented reading software requires that almost a whole screen be updated at a time, huge data transmission occurs when a page is changed or updated.

What is needed is a way to display content at a network client terminal device so that the client terminal device has a minimal computational requirement.

### SUMMARY OF THE INVENTION

The present invention provides a way to display content at a network client terminal device, such as a portable reading device, an electronic book or a portable terminal, so that the client terminal device has a minimal computational requirement. Accordingly, rich-styled text can be displayed on a network client terminal using adaptive and dynamic font selection, and adaptive font resolution.

The advantages of the present invention are provided by a method and system for displaying contents on a client terminal device received over a communication link, such as a computer network (i.e., a LAN, a WAN or the Internet), or a mobile telecommunications network, such as a GSM—(Global Standard for Mobile/Groupe Speciale Mobile), a GPRS—(General Packet Radio System), a UMTS—(Universal Mobile Telephone System) or 3G—(Third generation of mobile communications) based telecommunications network. Accordingly, when a 3G-based telecommunications system is used, such a 3G-based telecommunications system can be compatible with GSM, HSCSD (High Speed Circuit Switched Data), GPRS, EDGE (Enhanced Data Rates for Global/GSM Evolution) and/or WCDMA (Wideband Code Division Multiple Access communication techniques. Further, the present invention supports other types of mobile networks, such as CDMA—(Code Division Multiple Access), PDC—(Personal Digital Communications), CDMA2000-based communication networks.

Accordingly, a request is received at a host terminal device, such as a computer, from the client terminal device for selected content. A frequency of selected font characteristics for characters forming the selected content is determined at a host terminal device. A set of font images is then selected from a font library based on the determined frequency of selected font characteristics. Accordingly, the selected set of font images has fewer font images (i.e., about 256 patterns) than the font library. The selected set of font images is preferably compressed and sent from the host terminal device to the client terminal device over the communication link. Next, the content, which contains content location information and font pattern codes (i.e., index numbers of a font table), is preferably compressed and sent to the client terminal device over the communication on a page-by-page basis.

The selected set of font images is received and stored at the client terminal device. Then, the selected content is received at the client terminal device. Lastly, the content is displayed at the client terminal device based on the selected set of font images, the content location information and the font pattern codes for the content.

### BRIEF DESCRIPTION OF THE DRAWINGS

The present invention is illustrated by way of example and not limitation in the accompanying figures in which like reference numerals indicate similar elements and in which:

FIG. 1A shows a conceptual block diagram for a network-oriented electronic publishing system according to one embodiment of the present invention;

FIG. 1B shows a functional block diagram setting forth the structure of communications between a proxy server and a client terminal device according to one embodiment of the present invention;

FIG. 1C is a table setting forth information regarding request codes and return codes according to one embodiment of the present invention;

FIG. 2 shows a functional block diagram for a network-oriented electronic publishing system according to one embodiment of the present invention;

FIG. 3 illustrates an exemplary content, an intermediate description of the exemplary content rendered by a rendering engine, and a frequency of appearance table generated by an analyzer based on the exemplary content, all according to one embodiment of the present invention;

FIG. 4 shows a flow diagram for displaying contents on a client terminal device received over a communication link according to one embodiment of the present invention;

FIG. 5A graphically depicts a process for font appearance counting according to one embodiment of the present invention;

FIG. 5B graphically depicts a process for font image data creation according to one embodiment of the present invention; and

FIG. 5C graphically depicts a process for translating content to primitives according to one embodiment of the present invention.

### DETAILED DESCRIPTION

The present invention provides a technique for displaying rich-styled text contents on a remote terminal, such as an electronic book or a portable terminal, using adaptive and dynamic font selection, and adaptive font resolution.

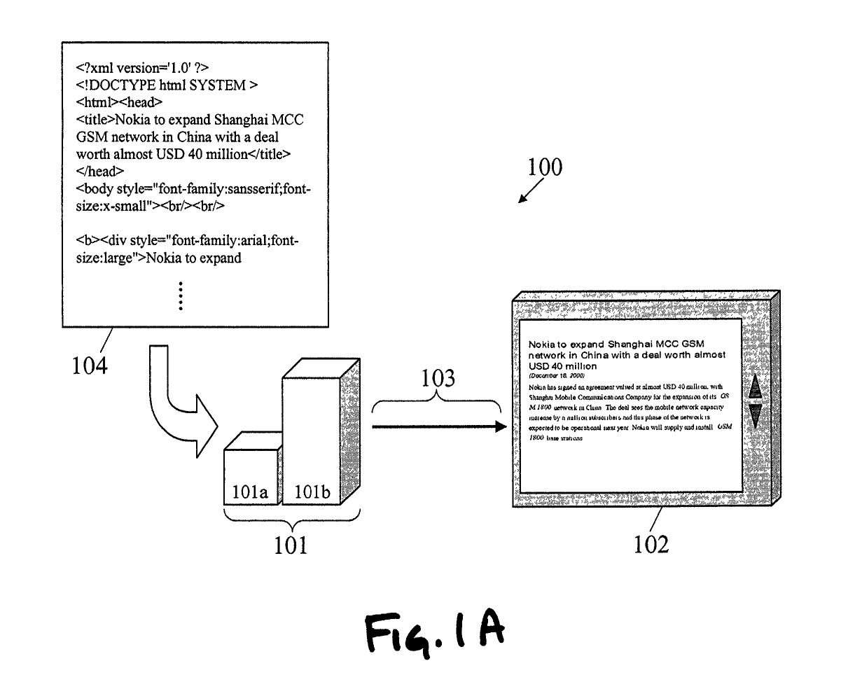

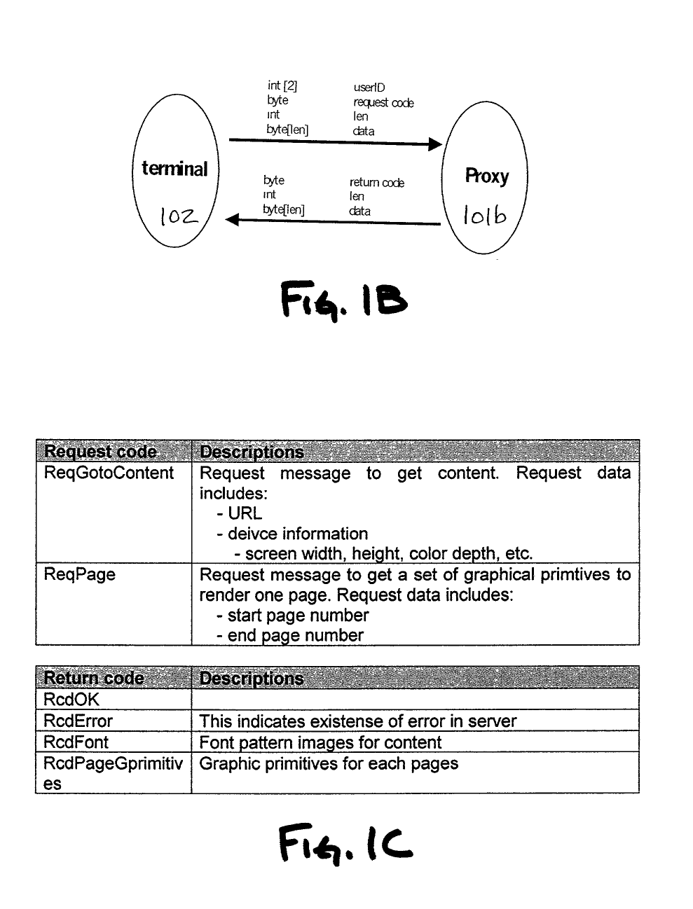

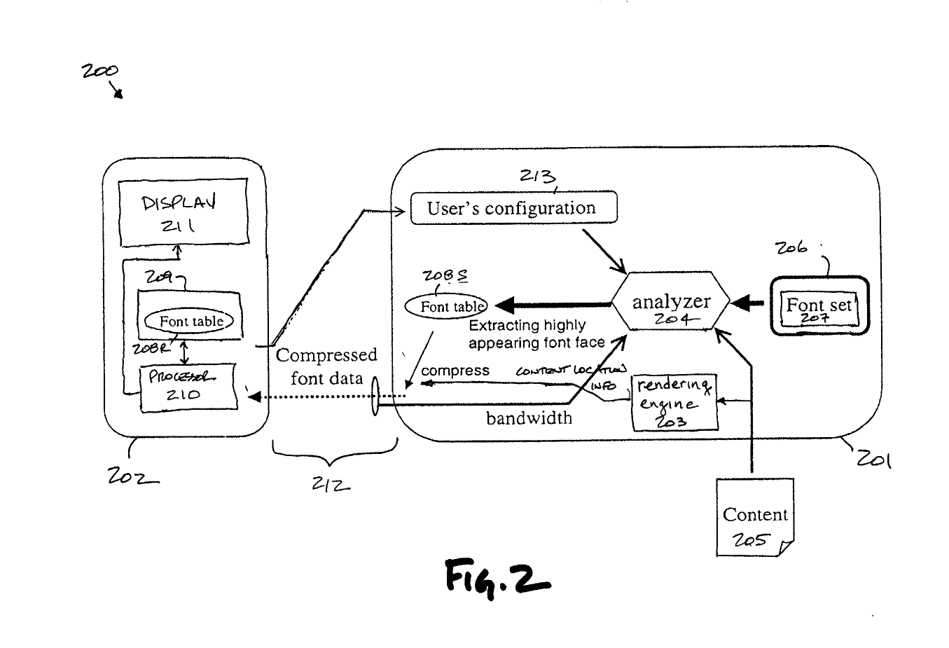

FIG. 1A shows a conceptual block diagram of a network-oriented electronic publishing system 100 according to one embodiment of the present invention. Electronic publishing system 100 includes a server system 101 and a remote terminal device 102, such as a portable reading device. Server system 101 and remote terminal device 102 are communicatively coupled in a well-known manner over a computer network 103, such as a telecommunications network (including wireless) or the Internet, so that server 101 and remote terminal device 102 operate as network devices. That is, server system 101 operates as a host terminal device and remote terminal 102 operates as a client terminal. Electronic publishing system 100 can also operate in a mobile telecommunications network, such as a GSM—(Global Standard for Mobile/Groupe Speciale Mobile), a GPRS—(General Packet Radio System), a UMTS—(Universal Mobile Telephone System) or 3G—(Third generation of mobile communications) based telecommunications network. Accordingly, when a 3G-based telecommunications system is used, such a 3G-based telecommunications system can be compatible with GSM, HSCSD (High Speed Circuit Switched Data), GPRS, EDGE (Enhanced Data Rates for Global/GSM Evolution) and/or WCDMA (Wideband Code Division Multiple Access communication techniques. Further, the present invention supports other types of mobile networks, such as CDMA—(Code Division Multiple Access), PDC—(Personal Digital Communications), CDMA2000-based communication networks.

Although, network connectivity is generally necessary for both server 101 and terminal device 102, the particular type of physical connection can be achieved using well-known techniques and protocols. While only a single remote terminal device 102 is shown in FIG. 1A, it should be understood that a plurality of remote terminal devices 102 could be part of publishing system 100. Moreover, remote terminal device 102 can include components and features, such as a transceiver, a user input device, etc., that are not shown in FIG. 1A.

Both server system 101 and terminal device 102 can be implemented using conventional operating systems and programming languages. Server system 101 provides all the processing capability and information for rendering content 104 on client terminal device 102. Specific requirements for server 101 include a memory having storage capability for libraries for handling contents, such as a conventional HTML parser or a conventional XML parser, a flexible conventional font generation system that generates, for example, a True Type font, and a conventional lossless compression method, such as LZ compression or Huffman coding.

In greater detail, server system 101 includes a portal and contents server 101a and a drawing proxy server 101b. The portal server aspect of server 101a provides processes relating to personalization of a portal site, such as portal content and portal settings. The contents server aspect of server 101a provides processes relating to contents using, for example, XHTML (Extensible Hypertext Markup Language) and/or Open ebook, content data, and access (rights) to content data. Drawing proxy server 101b provides rendering and translation processes. Regarding rendering processes, proxy server 101b parses and renders internal description of content and creates a set of drawing primitives. Regarding translation processes, proxy server 101b translates contents into compressed primitive messages providing an internal description of the content for display by client terminal device 102.

Portal and contents server 101a communicates with drawing server 101b in a well-known manner, such as by HTTP and/or TCP/IP. Drawing proxy server 101b communicates with client terminal device 102 also in a well-known manner, such as by TCP/IP. The basic structure of the communication between drawing proxy server 101b and client terminal device 102 is shown in FIG. 1B. Client terminal device 102 sends messages to drawing proxy server 101b relating to user identification information, request codes, int, byte[len], byte, int[2], data, and len. Drawing proxy server 101b sends messages to client terminal device 102 relating to byte, int, byte[len], return code, len, and data. FIG. 1C shows a table setting forth information regarding request codes and return codes.

Content location information (i.e., coordinate location) and font pattern codes (i.e., index numbers of a font table) are processed by server 101 and are transmitted to client terminal device 102 over computer network 103, such as the Internet. Server 101 provides all of the processing power for rendering, analyzing and transmitting content location and font pattern codes to client terminal device 102 as compressed primitive messages that are sent on a page-by-page basis. Thus, the initial loading time for the content is reduced. Client terminal device 102 is not required to render the contents for display, and requires only a simple graphical system and a decompression technique for displaying downloaded content. Moreover, client terminal device 102 is not required to have a large memory for storing large font libraries because client terminal device 102 is only required to store font pattern codes.

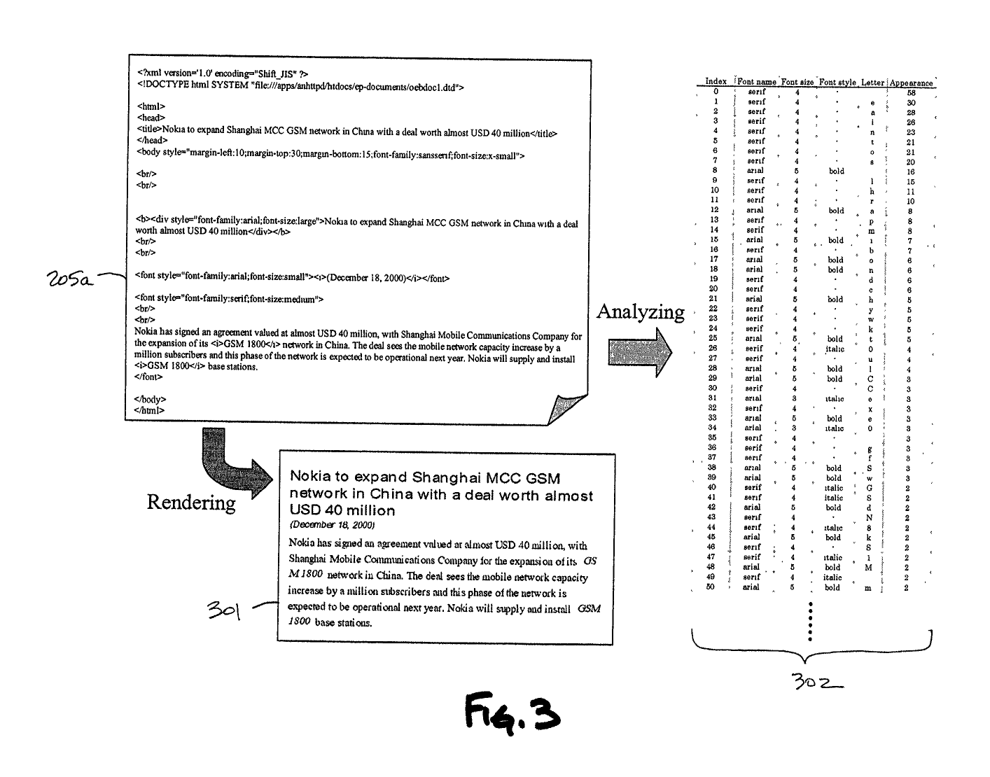

FIG. 2 shows a functional block diagram for a network-oriented electronic publishing system 200 according to one embodiment of the present invention. FIG. 2 shows that system 200 includes a server 201 and a client terminal device 202 that are communicatively coupled over computer network 209, such as the Internet. Server 201 includes a rendering engine 203 and an analyzer 204. Rendering engine 203 renders content 205 into an intermediate description. Analyzer 204, preferably in parallel with rendering engine 205; adaptively selects a font face by counting the frequency of the appearance characteristics of characters having particular attributes in the intermediate description of content 205, such as the particular letter, font (i.e., Arial, courier, times, etc.), style (i.e., bold and/or italic), and size. As used herein, a character is a symbol that represents an item, such as a letter or a number, in a particular writing system. For example, a lowercase-g is a character. When a particular character has been rendered, the rendered shape represents the character. As used herein, the rendered shape is called a glyph. Characters and glyphs do not necessarily have a one-to-one correspondence. For example, a lowercase-a acute can be represented by two glyphs: a lowercase-a and an acute. Another example is ligatures, such as ligature-fi, which is a single glyph representing two characters, f and i. A font, as used herein, is a collection of glyphs. Further, a font can have many faces, such as heavy, medium, oblique, gothic and regular. All of the faces of a particular font have a similar typographic design.

Server 201 also includes memory 206 for storing a complete font set 207. Based on the determined appearance characteristics, analyzer 204 selects a small font set 208S from the complete font set 207. Client terminal device 202 includes a memory 209, a processor 210 and a display 211. While only a single client terminal device 202 is shown in FIG. 2, it should be understood that a plurality of client terminal devices 202 could be part of publishing system 200.

When content, such as content 205, is requested by client terminal device 202, a small font set 208S of images (for example, up to 256 patterns) is adaptively selected by analyzer 204 from a complete font set 207 based on the frequency of appearance of particular attributes of the characters forming content 205. FIG. 3 illustrates an exemplary content 205a, an intermediate description 301 of exemplary content 205a rendered by rendering engine 203, and a frequency of appearance Table 302 generated by analyzer 204 based on exemplary content 205a, all according to one embodiment of the present invention. Exemplary content 205a is written in XHTML. A “-” in Table 302 represents a “plain” style.

Small font set 208S is then compressed and sent to client terminal device 202. Processor 210 decompresses and stores the small font set in memory 209 as small font set 208R. Small font set 208R is used for displaying content 205. Server 201 then compresses content 205 and sends compressed messages on a page-by-page basis to client terminal device 202 over computer network 212, as requested by terminal device 202. Processor 210 uses the content location information and font pattern codes sent by server 201 in the compressed messages for displaying the requested content on display 211.

The selected small font set 208S of, for example, about 256 font images is sufficient for ordinary English-language contents, although the same characters having a different font style or point size are preferably recognized by analyzer 204 as a different font pattern. Thus, the small font set stored selected by analyzer 204 changes or adapts to the specific content that is requested by terminal 202. The resolution for each font image can also be adaptively changed based on configuration information 213 for client terminal device 202, the connection bandwidth, or by applying a progressive image technique, such as multi-resolution data or interlacing, in a well-known manner. When another content is requested for display on terminal device 202, analyzer 204 analyzes the newly-requested content for selecting an appropriate small font set 208S, thereby creating a dynamic font set. Only a different font image, based on the newly-detected font characteristics will be sent to client terminal device 202, thereby reducing redundant data transmission over computer network 212.

Thus, by storing only a font table (i.e., a set of font patterns) for a font face having frequently-appearing characteristics in a client terminal device, instead of a complete font set, reduces memory usage within the client terminal device. Moreover, content analysis for font selection and rendering contents at server 201 reduce computation requirements within client terminal device 202, thereby providing a flexible content format. Further still, adaptive font resolution provided by server 201 provides a further advantage when connection bandwidth is low by reducing network traffic. Additional advantages gained from a server-centric computing technique of the present invention are that users are relieved from character code problems and frequent software updating.

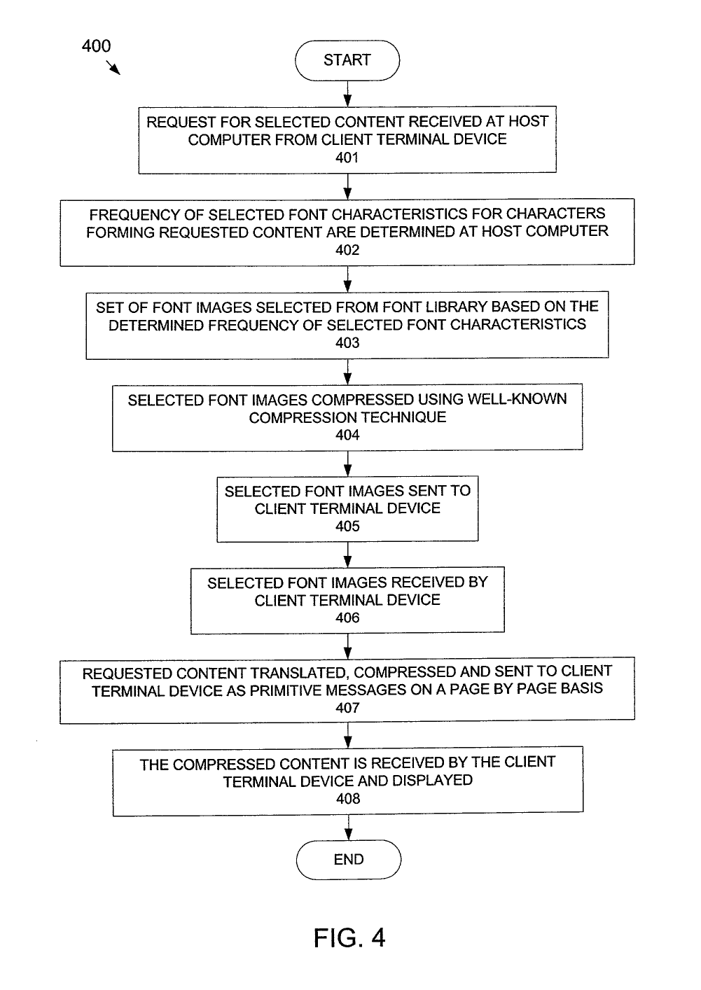

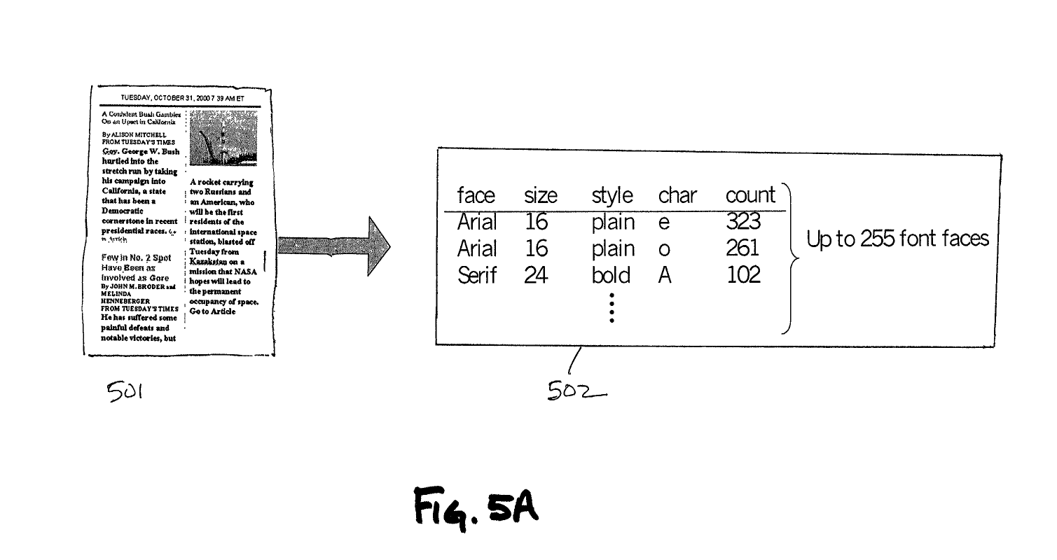

FIG. 4 shows a flow diagram 400 for displaying contents on a client terminal device received over a computer network, such as the Internet, according to one embodiment of the present invention. At step 401, a request for a selected content is received at a host terminal device from a client terminal device. At step 402, the frequency of selected font characteristics for characters forming the requested content are determined at the host terminal device. At step 403, a set of font images is selected from a font library based on the determined frequency of selected font characteristics. According to one embodiment of the invention, the selected set of font images has fewer font images than the font library. At step 404, the selected set of font images are compressed using a well-known lossless compression technique, such as LZ compression or Huffman coding.

Flow continues to step 405 where the selected set of font images are sent from the host terminal device to the client terminal device over the computer network. At step 406, the selected set of font images are received by the client terminal device. At step 407, the requested content is translated, compressed and sent to the client computer as compressed primitive messages on a page-by-page basis. The compressed primitive messages contain content location information and font pattern codes for the content. At step 408, the client terminal device receives the compressed primitive messages and displays the content using the content location information and the font pattern codes for the content. That is, the client terminal device reads the pattern specified by the pattern code from a font table and places the pattern image corresponding to the pattern code at a specified location on the display of the client terminal device. Each font pattern in the font table includes a width and height of the pattern image so that the client terminal device can automatically increase the x-location until the break of a line.

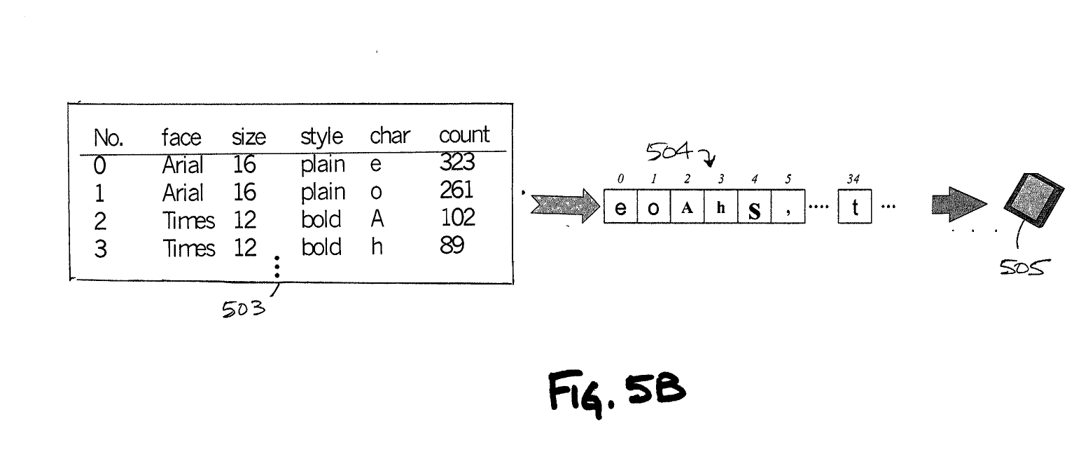

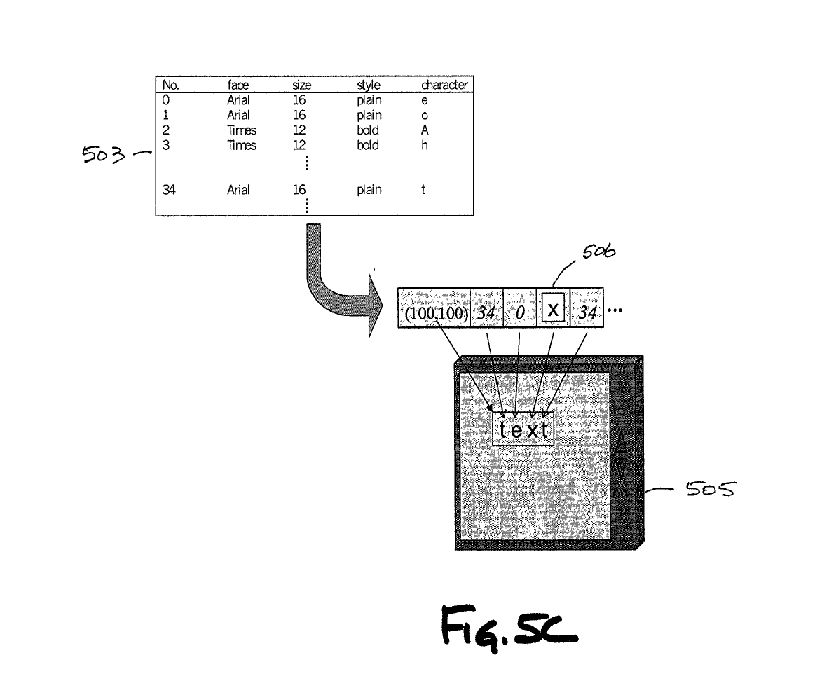

FIG. 5A graphically depicts a process for font appearance counting according to one embodiment of the present invention. FIG. 5A corresponds to step 402 in FIG. 4. In FIG. 5A, a Table 502 of frequently-appearing font faces is generated from the fonts appearing in content 501. To generate Table 502, font attributes, such as font face, size, style, and character, for each character appearing in content 501 is counted. For exemplary content 501, Table 502 contains a count of 323 for the character “e” having an Arial face, a size 16 and a plain style. Table 502 also contains a count of 261 for the character “o” having an Arial face, a size 16 and a plain style, and a count of 102 for the character “A” having a Serif face, a size 24 and a bold style. Preferably, Table 502 has entries for about 256 font faces.

FIG. 5B graphically depicts a process for font image data creation according to one embodiment of the present invention. FIG. 5B corresponds to step 403 in FIG. 4. In FIG. 5B, a Table 503 contains, preferably, about 256 font faces based on the font attribute count described in connection with FIG. 5A. An anti-aliased bitmap font image 504 (i.e., small font set 208S in FIG. 2) is generated for each character in Table 503. Preferably, the present invention uses a Java implementation so that a scalable and anti-aliased bitmap image can be easily generated from a True Type Font because Java supports True Type Font rendering. Bitmap font image 504 is sent to a client terminal device 505 before content data for content 501 (FIG. 5A) is sent to client terminal device 505.

FIG. 5C graphically depicts a process for translating content to primitives according to one embodiment of the present invention. FIG. 5C corresponds to step 407 in FIG. 4. After bitmap font image 504 is sent to client terminal device 505, each character forming content 501 is translated to a primitive using Table 503. For example, for an exemplary content 501, the word “text” translates to the primitive sequence “34”, “0”, a graphic primitive for “x”, and “34”. The character “t” for exemplary content 501 has been assigned the primitive “34”. (Thus, the character “t” had the thirty-fifth most font attribute frequency count.) Primitive “34” is defined by Table 503 to be the character “t” having an Arial face, a size 16 and a plain style. The character “e” for exemplary content 501 has been assigned the primitive “0”. Primitive “0” is defined by Table 503 to be the character “e” having an Arial face, a size 16 and a plain style. The character “x” was not defined in Table 503. Consequently, “x” is translated into a bitmap font image 506 and embedded in graphic primitives. The primitives are then sent to client terminal device 505.

While the present invention has been described in connection with the illustrated embodiments, it will be appreciated and understood that modifications may be made without departing from the true spirit and scope of the invention.

What is claimed is:

1. A method for displaying content on a client terminal device, the method comprising steps of:
determining at a host terminal device a frequency of selected font characteristics for characters forming the content;
selecting a set of font images from a font library based on the determined frequency of selected font characteristics, the selected set of font images having fewer font images than the font library; and
sending the selected set of font images from the host terminal device to the client terminal device over a communication link.

2. The method according to claim 1, wherein the communication link is a computer network.

3. The method according to claim 2, wherein the computer network is the Internet.

4. The method according to claim 1, wherein the communication link is a wireless communication system.

5. The method according to claim 1, wherein the communication link is a mobile communication network.

6. The method according to claim 1, further comprising a step of receiving a request from the client terminal device for the content.

7. The method according to claim 1, wherein the step of sending the selected set of font images to the client terminal device further includes a step of compressing the selected set of font images before sending the selected set of font images to the client terminal device.

8. The method according to claim 1, further comprising a step of sending the content to the client terminal device over the computer network, the content containing content location information and font pattern codes for the content.

9. The method according to claim 8, wherein the step of sending the content to the client terminal device over the computer network includes steps of compressing the selected content before sending the content to the client terminal device; and
sending the compressed content to the client terminal device over the communication link.

10. The method according to claim 8, wherein the step of sending the content to the client terminal device is done on a page-by-page basis.

11. The method according to claim 1, further comprising steps of:
receiving the selected set of font images at the client terminal device;
receiving the selected content at the client terminal device;
displaying the content at the client terminal device based on the selected set of font images, the content location information and the font pattern codes for the content.

12. A method for displaying content on a client terminal device, the method comprising steps of:
receiving a selected set of font images for content at the client terminal device, the selected set of font images being based on a frequency of selected font characteristics for characters forming the content and having fewer font images than a font library from which the selected set of font images is selected;
receiving the content at the client terminal device, the content containing content location information and font pattern codes for the requested content; and
displaying the content at the client terminal device based on the selected set of font images, the content location information and the font pattern codes for the content.

13. The method according to claim 12, wherein the content is received over a computer network.

14. The method according to claim 13, wherein the computer network is the Internet.

15. The method according to claim 12, wherein the content is received over a wireless communication system.

16. The method according to claim 12, wherein the content is received over a mobile communication network.

17. The method according to claim 12, wherein the received selected set of font images is compressed.

18. The method according to claim 12, wherein the received requested content is compressed.

19. The method according to claim 12, wherein the step of receiving the requested content is received on a page-by-page basis.

20. A system for displaying contents on a client terminal device, the system including a host terminal device comprising:
a memory storing a font library; and
an analyzer determining a frequency of selected font characteristics for characters forming a selected content and selecting a set of font images from the font library based on the determined frequency of selected font characteristics, the selected set of font images having fewer font images than the font library,
the host terminal device sending the selected set of font images to the client terminal device over a communication link.

21. The system according to claim 20, wherein the communication link is a computer network.

22. The system according to claim 20, wherein the computer network is the Internet.

23. The system according to claim 20, wherein the communication link is a wireless communication system.

24. The system according to claim 20, wherein the communication link is a mobile communication network.

25. The system according to claim 20, wherein the analyzer determines the frequency of selected font characteristics in response to receiving a request from the client terminal device for the selected content.

26. The system according to claim 20, wherein when the host terminal device sends the selected set of font images to the client terminal device, the host terminal device compresses the selected set of font images before sending the selected set of font images to the client terminal device.

27. The system according to claim 20, wherein the content sent to the client terminal device contains content location information and font pattern codes for the content.

28. The system according to claim 20, wherein the host terminal device compresses the selected content before sending the content to the client terminal device over the computer network.

29. The system according to claim 20, wherein the content is sent to the client terminal device on a page-by-page basis.

30. The system according to claim 20, wherein the client terminal device receives the selected set of font images, receives the selected content, and displays the content at the client terminal device based on the selected set of font images, the content location information and the font pattern codes for the content.

31. A client terminal device, comprising:
a memory receiving a selected set of font images, content location information and font pattern codes for a selected content received from a host terminal device, the selected set of font images and being based on a frequency of selected font characteristics for characters forming the selected content and having fewer font images than a font library from which the selected set of font images is selected; and
a processor generating a display of the selected content based on the selected set of font images, the content location information and the font pattern codes for the content.

32. The client terminal device according to claim 31, wherein the content is received over a computer network.

33. The client terminal device according to claim 32, wherein the computer network is the Internet.

34. The client terminal device according to claim 31, wherein the content is received over a wireless communication system.

35. The client terminal device according to claim 31, wherein the content is received over a mobile communication network.

36. The client terminal device according to claim 31, wherein the received selected set of font images is compressed.

37. The client terminal device according to claim 31, wherein the received content location information and font pattern codes are compressed.

38. The client terminal device according to claim 31, wherein the content is received on a page-by-page basis.
